(19) United States
(12) Patent Application Publication
(10) Pub. No.: US 2022/0372790 A1
(43) Pub. Date: Nov. 24, 2022

(54) Sleeve stop lock and related methods

(71) Applicants: William F. Van Duyne, San Diego, CO (US); Kannon Kobleur, San Diego, CA (US)

(72) Inventors: William F. Van Duyne, San Diego, CO (US); Kannon Kobleur, San Diego, CA (US)

(21) Appl. No.: 17/328,322

(22) Filed: May 24, 2021

(51) Int. Cl. E05B 15/02; E05B 15/10; E05B 63/00

(52) U.S. Cl. CPC E05B 15/0205; E05B 15/108; E05B 63/0004; E05B 65/0032

(57) ABSTRACT

Disclosed is a Sleeve Stop Lock that is a portable, removable, non-damaging door lock that can be used to secure almost any inward swinging door from the outside. The apparatus consists of three components: a sleeve, a stop, and a lock. The “sleeve” component fits around the edge of a door. It is installed while a door is open. With the door closed, the “stop” makes contact with the door frame once attached to the sleeve thus preventing the door from swinging inward. The “lock” mechanism then securely binds all of the components together. The combination of these three elements (sleeve, stop and lock) prevent potential intruders (including housekeeping) from entering and invading the privacy of an unoccupied room.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter is in the field of locks in general and door-locks in particular.

### Background of the Invention

Presently, a common practice for persons traveling or vacationing for a multi-day trip is to stay or sleep overnight in a private room at a hotel or other accommodation. While in the private room, security and privacy are typically important concerns. That is why travelers are known to lock the door to their room while it is occupied. But, even in a locked room there may be threats to a traveler's security or privacy that include thieves and hotel staff. So, additional protection above and beyond the standard hotel room door locks is desirable and beneficial.

The hotel staff threat to privacy and security can sometimes be reduced by the common practice of hanging a “Privacy Please” sign on the door in addition to locking the door. But, all too often, such signs are ignored, tampered, or disappeared and the result in those cases is a violation of the traveler's privacy since the staff can bypass the lock at will. So, there is a need for a better door lock to protect privacy from staff.

Privacy and security are also necessary when the traveler is not occupying the room because it is common for travelers to leave valuables or personal items inside their hotel room. Even with a locked door, the traveler's items are vulnerable to theft. Currently, no portable security systems exist to augment a lock of an unoccupied room. Therefore, an additional portable layer of security is both desirable and beneficial to a traveler when outside their room.

### SUMMARY OF THE INVENTION

In view of the foregoing, an object of this specification is to disclose an improved lock that is succinctly described as “sleeve stop lock” or “SSL.” The SSL may suitably be a portable, removable, non-damaging door lock that can be used to augment the door's lock and assist the existing lock in securing almost any inward swinging door from outside the locked room. The SSL is an apparatus and related methods of using the same.

The SSL apparatus generally comprises three components: a sleeve, a stop, and a lock. The sleeve component may suitably be adapted to fit around the edge of a door so that at least one shaft extends at a normal or other oblique angle from the face of the door. The sleeve may be installed while a door is open but after the sleeve is installed the door may be closed to secure it in place between the door and the door frame so that the shaft extends at the normal direction. With the door closed, the stop component may be provided over the shaft until it makes contact with the door frame so that, once securely attached to the shaft of the sleeve via the lock, the stop can prevent the door from swinging inward. The lock mechanism then securely binds all of the components together, e.g., via sandwiching the stop between the lock and sleeve. The combination of these three elements (sleeve, stop and lock) is thought to augment an existing door lock in an attempt to prevent potential intruders (including housekeeping or other staff) from entering and invading the privacy of an unoccupied room.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1 is the preferred embodiment of an SSL design fully assembled and in use. Both top and exterior face views show that when the SSL is securely attached via the Lock component to a door and doorframe, the Stop component prevents a door from opening by contacting a doorframe while the Sleeve component grips around a door.

FIG. 2 shows the preferred embodiment exterior face view SSL fully assembled without a door or doorframe.

FIG. 3 shows images of an embodiment of an SSL Sleeve-Shaft assembly fitted around a closed door, an embodiment of an SSL assembled with a door closed and secured, and a disassembled prototype SSL ready for travel.

FIG. 4 shows the Sleeve component with holes allowing for the Shaft insertion and protrusion.

FIG. 5 shows the Sleeve component with the Shaft inserted and ready to slide onto a door edge.

FIG. 6 shows an exploded view of the Shaft Stop Lock alignment.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

Disclosed is an improved lock referred to herein as “SSL.” The SSL may suitably be a portable, removable, non-damaging door lock that can be used to augment the door's lock and assist the existing lock in securing almost any inward swinging door from outside the locked room. The SSL is an apparatus and related methods of using the same and generally comprises three components: a sleeve, a stop, and a lock. The more detailed description of the disclosed SSL is recited with reference to the attached FIGS.

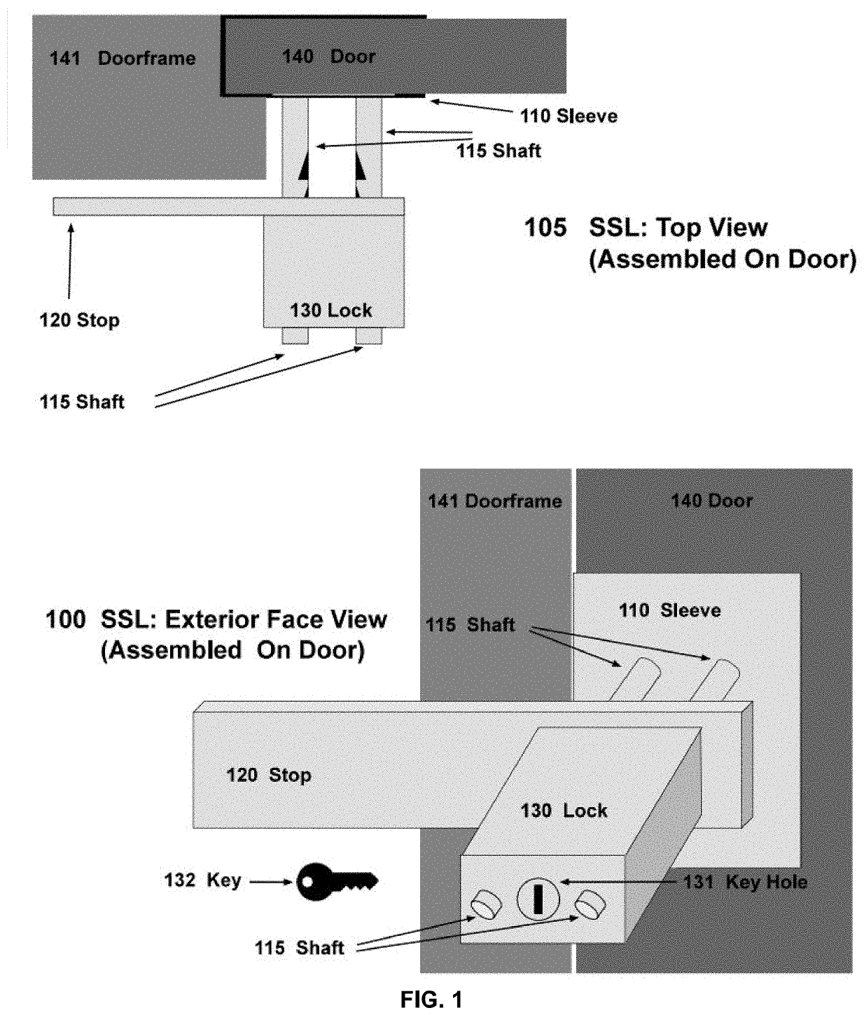

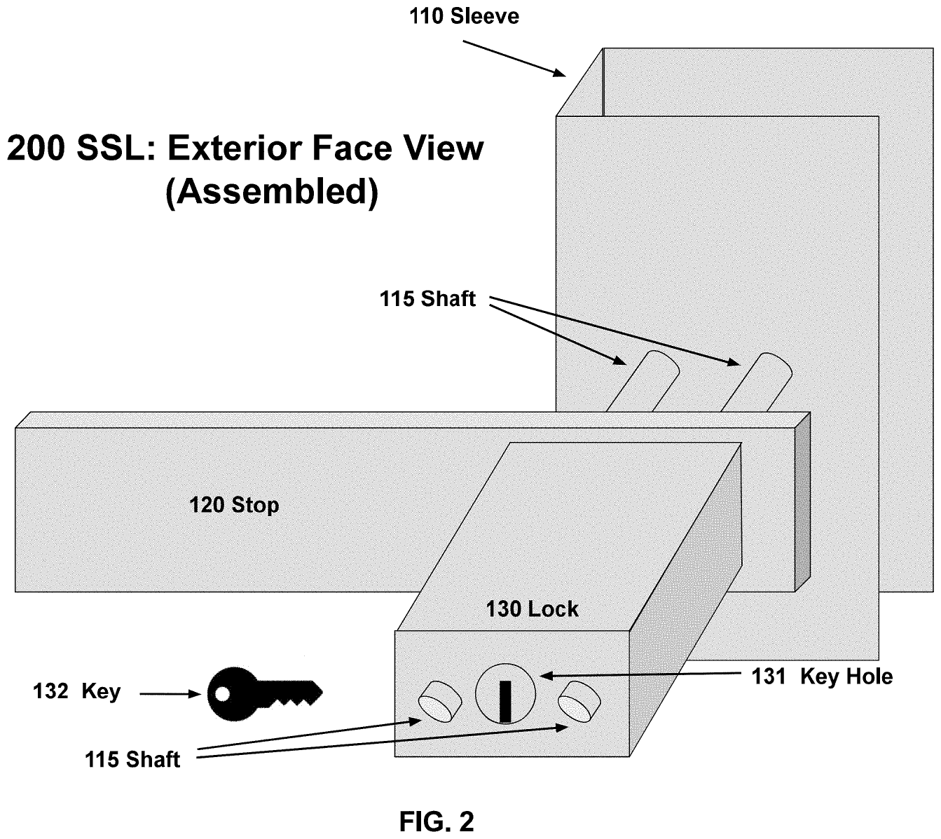

FIG. 1 shows the preferred embodiment installed on the exterior face of a door and from a straight on view 100 and from a top view 105. FIG. 2 shows the exterior face view 200 of SSL without the Door 140 and Doorframe 141. As shown, the SSL secures an inward swinging Door 140. In other embodiments, SSL could secure other inward swinging openings including but not limited to standard or non-standard: storage facility doors, commercial/industrial doors, interior home or workplace doors, cabinet doors, pet doors, and windows. It should be understood that, in all conceivable embodiments, an SSL may suitably be an apparatus and related methodologies for preventing a hinged object from hinging within a frame. Suitably, an SSL is both portable and easy to install or remove. SSL is compact and lightweight, thereby making it convenient for travel. No tools or hardware such as screws are required, which allows easy installation and removal without damaging the Door 140 or Doorframe 141.

Still referring to FIGS. 1 and 2, the exterior face view 100 and top view 105 show the three preferred components of SSL, namely the Sleeve 110, Stop 120 and Lock 130. These three components work together to accomplish all of SSL's defining attributes: security, portability, and ease of use. With the Door 140 in an open position, the Shaft 115 acts as an extension to the Sleeve 110 and has been coupled with the Sleeve 110 and slid over the edge of the Door 140. In other embodiments, the Sleeve 110 could be permanently connected to the Shaft 115 and slid over the edge of the Door 140. When the Door 140 is in the closed position and housed in the Doorframe 141, the Stop 120 is slid onto the Shaft 115. After the Stop 120 is in place, the Lock 130 is slid onto the Shaft 115. The Lock 130 prevents the Stop 120 from sliding off the direction it was assembled. With Lock 130 and Stop 120 components in place, if an attempt is made to open the door, the Stop 120 works in conjunction with the Doorframe 141 to prevent entry. The Key Hole 131 allows for a Key 132 to remove the Lock 130 and Stop 120 from the Shaft 115.

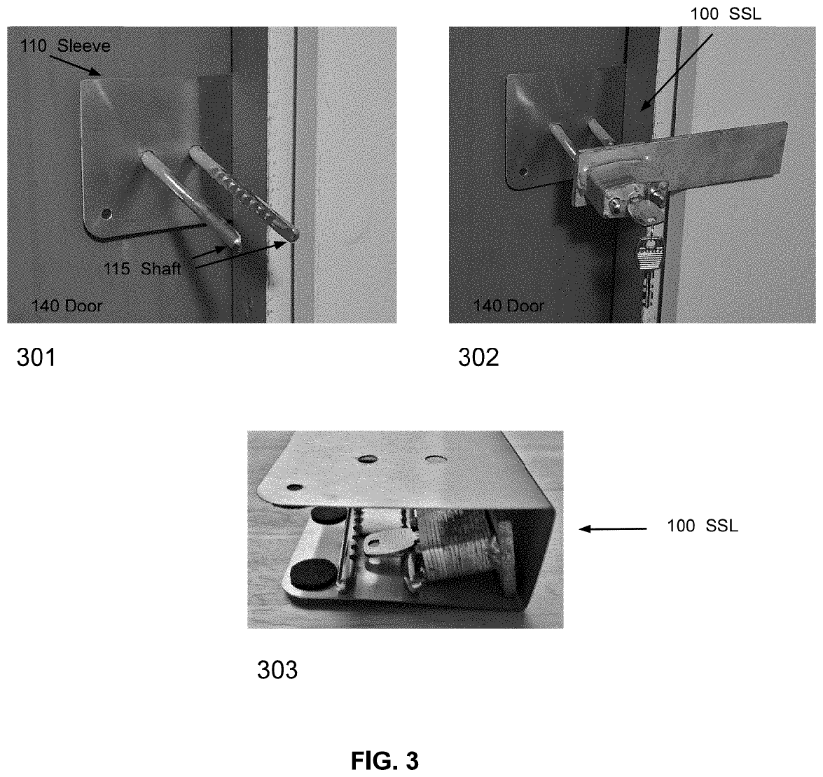

FIG. 3 shows three images of an embodiment of the SSL 100 in various states of assembly. 301 shows an embodiment of a Sleeve 110 and Shaft 115 assembly fitted around a closed Door 140. 302 shows an embodiment of an SSL 100 assembled with a Door 140 closed and secured. 303 shows a disassembled prototype SSL 100 ready for travel in a compact form factor. Even though the depicted embodiment captures the security, portability and ease of use benefits of the invention, those skilled in the art will see the obvious benefit of further implementation refinements for mass production and economies of scale.

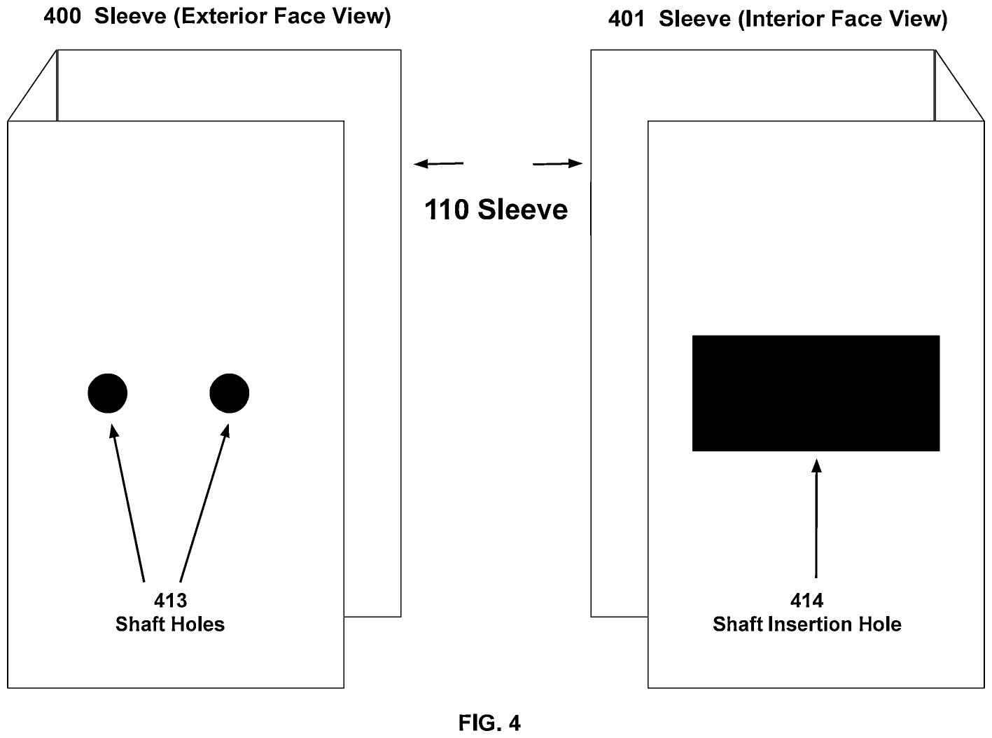

FIG. 4 shows a view of both the Sleeve (Exterior Face View) 400 and Sleeve (Interior Face View) 401. As shown, the Sleeve (Interior Face View) 401 side could have a Shaft Insertion Hole 414 allowing for the Shaft 115 to enter the Sleeve 110 and protrude through the Shaft Holes 413 on the Sleeve (Exterior Face View) 400 side. Other embodiments are contemplated.

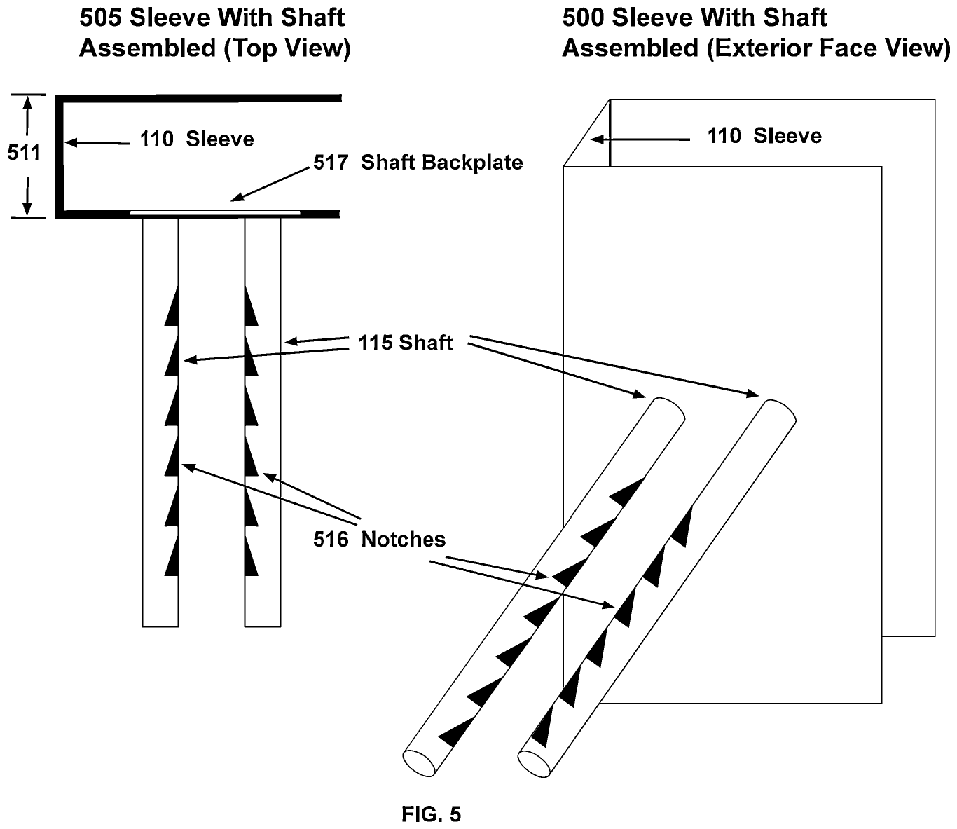

FIG. 5 shows the Sleeve with Shaft Assembled (Exterior Face View) 500 and a Sleeve with Shaft Assembled (Top View) 505 using the Shaft Insertion Hole 414 and Shaft Holes 413 as described above. The Shaft 115 could have multiple Notches 516 allowing for various Doorframe 141 depths depending on where the Lock 130 is placed. The Shaft 115 has in the preferred embodiment two individual shafts that are permanently connected to the Shaft Backplate 517. The Shaft Backplate 517 preferably stops the Shaft 115 from slipping through the Sleeve 110 Shaft Holes 413. The dual Shaft design 115 may assist in preventing the Stop 120 and the Lock 130 from rotating. In other embodiments, the number of shafts could be more or less than what is depicted, e.g., at least one shaft or more than two shafts. In case only one shaft is used, the shaft could have a square shape instead of a circular shape which would prevent Stop 120 and Lock 130 rotation. In other embodiments, the shaft could have a polygonal shape for the same reason.

Still referring to FIG. 5, the Shaft 115 may be constructed of stainless steel. In other embodiments, a shaft may be constructed of any material that meets the strength and durability requirements. The Sleeve 110 is constructed of a thin gauge stainless steel that is thin enough so that the Door 140 closes, but thick enough for strength and durability. In other embodiments, a different material may be used for the sleeve that meets the thickness, strength and durability requirements. The interior portion of the Sleeve 110 may contain material such as felt to reduce friction and prevent scratches when the Sleeve 110 is slid onto the Door 140. The preferred embodiment Sleeve nominal thickness 511 is 1.75″ which corresponds to a standard hotel room door. In other embodiments, the Sleeve thickness 511 may change to accommodate any of the other potential inward swinging opening doors or windows.

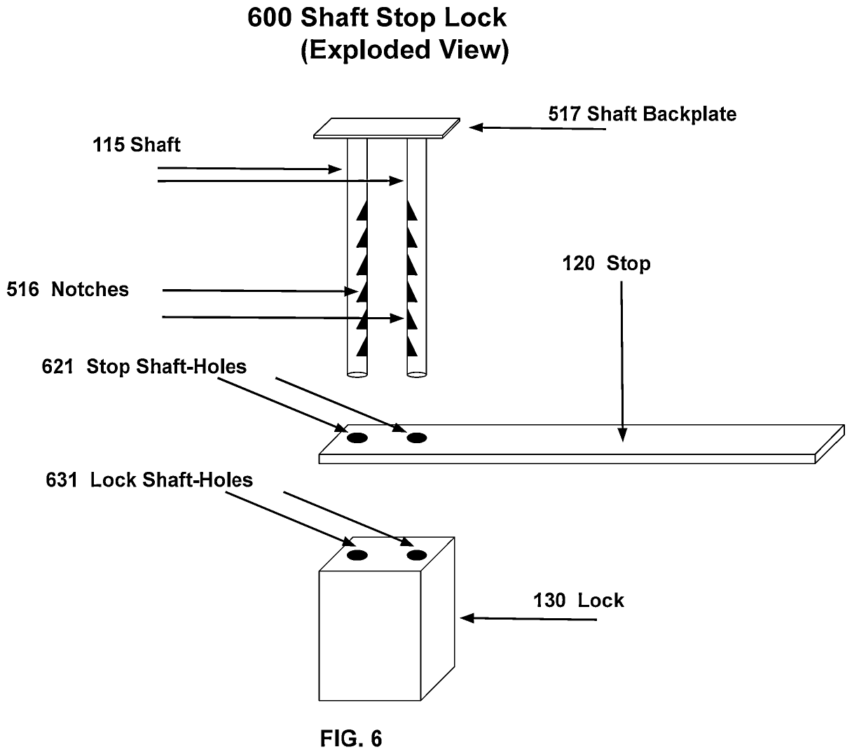

FIG. 6 shows an exploded view 600 of the Shaft 115, Stop 120 and Lock 130 where the alignment of the three highlighted components allows for easy installation and removal from a door. In the preferred embodiment, the Stop 120 and the Lock 130 are separate components. In other embodiments, the Stop 120 and Lock 130 functions could be combined into a single stop/lock component. The Shaft 115 with its Shaft Backplate 517 and its Notches 516 is shown to be aligned with a mating component. The Stop Shaft-Holes 621 suitably allow the Stop 120 to slide over the Shaft 115 and contact the Doorframe 141. Similarly, the Lock Shaft-Holes 631 allow the Lock 130 to slide over the Shaft 115 and lock as far as possible over the Notches 516 so that the Lock 130 and Stop 120 components can be situated as close as possible to the Door 140, thus securing the Door 140.

In the preferred embodiment, the Stop 120 is made of heavy gauge stainless steel. In other embodiments, the Stop 120 could be made of any strong and durable material. In other embodiments, an inward swinging door or window may also be able to swing outward. For this inward and outward swinging door or window embodiment, an additional stop mechanism may be placed on the interior side of the door in the same manner described above for the outside. Alternatively, for this inward and outward swinging door or window embodiment, an additional stop mechanism may be integrated as a part/extension of the sleeve interior face 401.

In the preferred embodiment, the Lock 130 is self-locking as it glides over the Notches 516 and could involve a Key 132 to unlock the SSL apparatus 100. In other embodiments, the Lock 130 could require a key to attach as well as remove the Lock 130 from the Shaft 115. In yet other embodiments, another locking mechanism may be used, including but not limited to mechanical combination locks, electro-mechanical combination locks, or locks that leverage technology including but not limited to biometric or other sensors, Near-Field Communication (NFC), Bluetooth, WiFi, cellular, internet-based connections, the World Wide Web, Web browsers or Apps. In other embodiments, the SSL apparatus 100 may add functionality and technology including but not limited to intrusion detection or other sensors, cameras with audio and video, alarms, Near-Field Communication (NFC), Bluetooth, WiFi, cellular, internet based connections, the World Wide Web, Web browsers or Apps.

The following process flow refers to the figures and may define a five step procedure to install a preferred embodiment of an unassembled SSL 100 on a basic Door 140 or window:
Step 1: Slide the Shaft 115 through the openings 414 and 413 of the Sleeve 110.
Step 2: With the Door 140 open, fit the Sleeve 110 and Shaft 115 around the edge of the Door 140.
Step 3: Close the Door 140.
Step 4: Slide the Stop 120 over the Shaft 115 so that the Stop 120 makes contact with the Doorframe 141.
Step 5: Slide the Lock 130 over as many Notches 516 as possible, while the Stop 120 is still making contact with the Doorframe 141.

The following process flow refers to the figures and may define a four step procedure to remove an assembled SSL 100 from a basic Door 140:
Step 1: With the Door 140 closed and locked, use the Key 132 to unlock the Lock 130 via the Lock Key Hole 131.
Step 2: Remove the Lock 130 and Stop 120 from the Shaft 115.
Step 3: Open the Door 140.
Step 4: Remove the Sleeve 110 and Shaft 115 from the Door 140.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. An apparatus that prevents a hinged object from swinging within a frame comprising:
a. a sleeve that is provided to an edge of the object and positioned between said edge and an edge of the frame;
b. one or more shafts extending from the sleeve and relative to a plane of the object;
c. one or more stops that are penetrated by at least one of the one or more shafts or integrated as a part/extension of the sleeve and situated so that it interfaces the edge of the frame; and,
d. a lock that is positioned on the shaft to retain an interface between the stop and the edge of the frame.

2. The apparatus of claim 1 wherein the apparatus is installable and removable from said object.

3. The apparatus of claim 1, may be disassembled into a compact form factor for portability.

4. The apparatus of claim 1, where the sleeve is adapted to the thickness of the hinged object.

5. The apparatus of claim 1, where the one or more shafts could be cylindrical, square, or polygonal in shape.

6. The apparatus of claim 1, where the frame has various depths.

7. The apparatus of claim 1, where the hinged object is a standard or non-standard inward swinging door or window.

8. The apparatus of claim 1, where the lock is selected from the group consisting essentially of: a keyed lock, mechanical combination lock, electro-mechanical combination lock, or a lock that leverages technology including but not limited to biometric or other sensors, Near-Field Communication (NFC), Bluetooth, WiFi, cellular, internet based connections, the World Wide Web, Web browsers or Apps.

9. The apparatus of claim 1, where the apparatus supports additional functionality and technology including but not limited to intrusion detection or other sensors, cameras with audio and video, alarms, Near-Field Communication (NFC), Bluetooth, WiFi, cellular, internet based connections, the World Wide Web, Web browsers or Apps.

10. A method of locking a hinged object comprising the steps of:
(a) sliding at least one shaft through a front surface of a sleeve;
(b) fitting the sleeve over an edge of the hinged object so that the shaft extends from the sleeve and relative to a plane of the object;
(c) hinging the object to within a frame;
(d) penetrating a stop via the shaft so that the stop makes contact with the frame.

11. The method of claim 10 further comprising the step of:
(e) penetrating a lock via the shaft so that the lock retains the stop in a situation of contact between the stop and the frame.

12. The method of claim 11 further comprising the step of:
(f) locking the lock.

13. The method of claim 12 further comprising the step of:
(g) unlocking the lock.

14. The method of claim 13 further comprising the step of:
(h) removing the lock from the shaft.

15. The method of claim 14 further comprising the step of:
(i) removing the stop from the shaft.

16. The method of claim 15 further comprising the step of:
(j) hinging the object out of the frame.

17. The method of claim 16 further comprising the step of:
(k) removing the sleeve and shaft from the object.

18. The method of claim 17 further comprising the step of:
(l) removing the shaft from the sleeve.

19. A kit for constructing an apparatus that prevents a hinged object from swinging within a frame comprising:
a. a sleeve that is configured to interface an edge of the object so that, while interfacing said edge, the sleeve is positioned between said edge and an edge of the frame;
b. one or more shafts that are configured to extend from the sleeve and relative to a plane of the object when assembled with the sleeve;
c. one or more stops that are configured for penetration by at least one of the one or more shafts or integrated as a part/extension of the sleeve so that the stop is situated to interface the edge of the frame; and,
d. a lock that is configured to be positioned on the shaft to retain the interface between the stop and the edge of the frame.

20. The kit of claim 19, where the lock is selected from the group consisting essentially of: a keyed lock, mechanical combination lock, electro-mechanical combination lock, or a lock that leverages technology including but not limited to biometric or other sensors, Near-Field Communication (NFC), Bluetooth, WiFi, cellular, internet based connections, the World Wide Web, Web browsers or Apps.
